(19) United States
(12) Patent Application Publication
(10) Pub. No.: US 2014/0292501 A1
(43) Pub. Date: Oct. 2, 2014

(54) APPARATUS AND METHOD FOR PROVIDING HAPTIC EFFECT USING SOUND EFFECT

(71) Applicant: ELECTRONICS AND TELECOMMUNICATIONS RESEARCH INSTITUTE, Daejeon-city (KR)

(72) Inventors: Jeong-Mook LIM, Daejeon (KR); Hee-Sook SHIN, Daejeon (KR); Jong-Uk LEE, Gyeongsangbuk-do (KR); Ki-Uk KYUNG, Daejeon (KR)

(73) Assignee: ELECTRONICS AND TELECOMMUNICATIONS RESEARCH INSTITUTE, Daejeon-city (KR)

(21) Appl. No.: 14/012,149

(22) Filed: Aug. 28, 2013

(30) Foreign Application Priority Data
Mar. 27, 2013 (KR) 10-2013-0032962

(51) Int. Cl. G08B 6/00

(52) U.S. Cl. CPC G08B 6/00
USPC 340/407.2

(57) ABSTRACT

Disclosed herein are an apparatus and method for providing a haptic effect using a sound effect. The apparatus includes an audio filter storage unit, an acquisition unit, an analysis unit, a message configuration unit, and a haptic output unit. The audio filter storage unit stores a plurality of adaptive audio filters. The acquisition unit obtains sound effects output by an electronic device in response to an application or a user input event. The analysis unit analyzes the frequency components of each of the sound effects. The message configuration unit detects at least one of the adaptive audio filters from the audio filter storage unit, and generates a haptic output message, corresponding to the sound effect. The haptic output unit outputs a haptic effect based on the haptic output message. The adaptive audio filter dynamically varies depending on the application or the user input event.

### CROSS REFERENCE TO RELATED APPLICATION

This application claims the benefit of Korean Patent Application No. 10-2013-0032962, filed on Mar. 27, 2013, which is hereby incorporated by reference in its entirety into this application.

### BACKGROUND OF THE INVENTION

1. Technical Field

The present invention relates generally to an apparatus and method for providing a haptic effect using a sound effect and, more particularly, to an apparatus and method for providing a haptic effect using a sound effect, which provide a haptic effect to a user based on a sound effect via a haptic device equipped with an actuator.

2. Description of the Related Art

A haptic function is a technology that provides tactile sensations to a user by generating vibrations, force, or an impact through a digital device. That is, a haptic function provides a user with vibrations, a sensation of motion, or force when the user manipulates an input device (e.g. a joystick, a mouse, a keyboard, or a touch screen) of a digital device, such as a game machine, a mobile phone or a computer. Accordingly, the haptic function delivers more realistic information to a user, like a computer virtual experience.

In the early stage of development, the haptic function was chiefly applied to aircraft and fighter plane simulations, virtual video experience movies, and games. Since the release of touch screen mobile phones adopting a haptic function in the mid-2000s, it has become familiar to individual users and has attracted attention.

As described above, a haptic function has been used in various types of electronic devices, such as smart phones and game consoles. As user demand for interactions with media using a complex method in which the sense of touch and the sense of smell in addition to the senses of sight and hearing are used together is increasing, the use of the haptic function is increasing accordingly.

In general, in a conventional method of providing haptic feedback, a haptic function is driven by an event that is generated when a user manipulates a digital device, or an event that is generated by an application itself. That is, this haptic function is triggered by a specific event that is generated when a user interacts with a digital device through a user interface, or an event (e.g., an alarm) that is generated by an application itself. As described above, in this method of providing haptic feedback, an event-driven method that outputs a predetermined haptic pattern in response to a generated event is commonly used.

Another method of providing haptic feedback includes a method of changing continuously output audio data into data for haptic output and then providing haptic feedback. In this case, an analog signal method and a Fast Fourier Transform (FFT) filter method are used as methods of changing audio data being output into haptic data.

The analog signal method is a method of operating a haptic actuator using an analog signal, generated when audio is output, as input. The analog signal method has a very fast response speed, and can be easily implemented as hardware. In particular, when the haptic actuator has various driving frequency ranges, the analog signal method can be used more effectively. For example, Korean Patent Application Publication No. 10-2011-0076283 entitled “Method and Apparatus for providing Feedback according to User Input Pattern” discloses a technology for detecting haptic patterns or haptic audio patterns in response to user input in a mobile communication terminal equipped with a touch screen and providing the same feedback to a counterpart communication terminal by sending pattern information corresponding to at least one pattern to the counterpart communication terminal.

However, the analog signal method is disadvantageous in that haptic feedback is output in response to a signal in a desirable frequency band because haptic feedback is output in response to all audio signals that are generated by a digital device. For example, a digital device for a game commonly uses background music together with a variety of sound effects. In this case, some audio (or some sound) can maximize a user experience when it is provided along with haptic feedback. However, this may cause user inconvenience because the audio (or the sound) and the haptic feedback are provided at the same time.

For example, in the case of a car racing game in which a car race is performed on a specific track, a variety of sound effects, such as an engine acceleration sound, a sound of friction between wheels and the surface of a road, a sound of collision with another vehicle or an adjacent object, and background music making the game exciting may be provided during the game. The engine acceleration sound, the friction sound, and the collision sound may provide more realistic feedback to a user when they are provided along with haptic effects. In contrast, when the background music output as background sound regardless of driving is delivered along with haptic effects, a problem arises in that the sensation of reality may be deteriorated because the haptic feedback not related to vehicle driving is delivered. This problem occurs because haptic feedback is provided in response to all frequency components without distinguishing the major frequency components of the engine acceleration sound, the friction sound, and the collision sound from the major frequency components of the background music.

In the FFT filter method, audio signals are filtered according to their frequency band, and haptic feedback is provided using the filtered audio signals. The FFT filter method is used to overcome the problems of the analog signal method, and is performed in such a way as to convert audio data being played into blocks at specific time intervals, detect the frequency components of each of the audio blocks using an FFT filter, and provide haptic feedback based on the magnitude of the detected frequency components, that is, the loudness for each frequency. Accordingly, different haptic effects may be provided in response to a low frequency band and a high frequency band.

However, the FFT filter method is problematic in that it requires a very elaborate filtering process, such as the setting of an audio sampling time interval and the setting of a threshold in each frequency band for filtering, in order to provide effective haptic feedback that well matches audio being output. That is, in order to distinguish the engine acceleration sound, the friction sound, and the collision sound from the background music, the distribution characteristics of each frequency band for each sound effect should be modeled and then filtering should be performed. However, it is very difficult to construct a common model that can be applied to a variety of sound effects in the same manner.

Actually, some sounds may maximize a user experience when being provided along with haptic feedback, whereas some sounds may cause user inconvenience when being provided along with haptic feedback. Furthermore, if the sounds have similar frequency components, it is difficult to filter the sounds according to their sound effect. As a result, it is not easy to generate haptic feedback by applying the method only to a sound effect desired by a user.

For example, in the case of a car racing game in which a race is performed along a specific track, although the frequency components of a specific sound effect have been analyzed, the analyzed frequency components may overlap the frequency components of background music. Accordingly, although the engine acceleration sound, the friction sound, and the collision sound are filtered and haptic effects corresponding to the filtered sounds are provided, there is a strong possibility of an unwanted haptic effect being provided in response to background music. Accordingly, haptic feedback is generated in response to all sound effects because the major frequency components of a specific sound effect are not easily distinguished from the major frequency components of background music. As a result, a problem arises in that it is difficult to maximize a user experience via haptic feedback.

Furthermore, the FFT filter method is problematic in that it requires a filtering process attributable to the frequency components of audio being output by an application running on an electronic device, and a conventional sound filtering process based on the loudness for each frequency is very complicated for application only to a sound effect desired by a user or cannot perform precise filtering.

### SUMMARY OF THE INVENTION

Accordingly, the present invention has been made keeping in mind the above problems occurring in the prior art, and an object of the present invention is to provide an apparatus and method for providing a haptic effect using a sound effect, which provide a haptic effect capable of maximizing an effective user experience by performing Fast Fourier Transform (FFT) on audio blocks obtained through sampling, detecting frequency components in the transformed audio blocks, and removing frequency components for which haptic effects are not required from the detected frequency component based on previously stored adaptive audio filters.

Another object of the present invention is to provide an apparatus and method for providing a haptic effect using a sound effect, which previously set adaptive audio filters each including frequency components, a threshold, and the output frequency of an actuator and overcome the complexity of a frequency filtering process attributable to audio frequency components being output.

In accordance with an aspect of the present invention, there is provided an apparatus for providing a haptic effect using a sound effect, including an audio filter storage unit configured to store a plurality of adaptive audio filters; an acquisition unit configured to obtain sound effects output by an electronic device in response to an application or a user input event; an analysis unit configured to analyze frequency components of each of the sound effects obtained by the acquisition unit; a message configuration unit configured to detect at least one of the adaptive audio filters from the audio filter storage unit based on the application or the user input event, and to generate a haptic output message, corresponding to the sound effect, based on the detected adaptive audio filter and the frequency components analyzed by the analysis unit; and a haptic output unit configured to output a haptic effect based on the haptic output message received from the message configuration unit, wherein the adaptive audio filter dynamically varies depending on the application or the user input event.

The audio filter storage unit may store the name of the application, the user input event, and a plurality of frequency characteristics, and the frequency characteristics may include frequency components, a intensity threshold, and an output frequency.

The acquisition unit may obtain audio blocks from the sound effect generated by the electronic device based on a sound source sampling rate, and may send the obtained audio blocks, together with the application or the user input event, to the analysis unit.

The acquisition unit may set the sound source sampling rate based on the performance of the electronic device and the characteristics of the application running on the electronic device, or may set a sound source sampling rate received from a user as the sound source sampling rate.

The analysis unit may analyze the frequency components of the sound effect by performing Fast Fourier Transform (FFT) on each of audio blocks received from the acquisition unit, and may send the analyzed frequency components, together with the application or the user input event received from the acquisition unit, to the message configuration unit.

The message configuration unit may detect frequency components, each having a intensity equal to or higher than a threshold included in the detected adaptive audio filter, among the frequency components received from the analysis unit, may detect an output frequency corresponding to the detected frequency components from the detected adaptive audio filter, and may generate the haptic output message including the detected output frequency.

The apparatus may further include a haptic mode setting unit configured to generate the adaptive audio filter based on the sound effect generated in response to the application or the user input event and to store the generated adaptive audio filter in the audio filter storage unit.

The haptic mode setting unit may include a collection module configured to collect the sound effects generated in response to the application executed on the electronic device or the user input event using the application or the user input event as a key; an analysis module configured to classify the collected sound effects into a plurality of types of sound effect data according to the application or the user input event using a time, an audio frequency band, and the intensity of each frequency band as feature vectors; and a generation module configured to generate adaptive audio filters based on the classified sound effect data.

The generation module may generate the adaptive audio filters, each including the name of the application, the user input event, and a plurality of frequency characteristics; and the frequency characteristics may include frequency components, a intensity threshold, and an output frequency.

In accordance with an aspect of the present invention, there is provided a method of providing a haptic effect using a sound effect, including obtaining, by an acquisition unit, sound effects generated by an electronic device in response to an application or a user input event; analyzing, by an analysis unit, frequency components of each of the obtained sound effects; detecting, by a message configuration unit, at least one adaptive audio filter based on the application or the user input event; generating, by the message configuration unit, a haptic output message, corresponding to the sound effect, based on the detected adaptive audio filter and the analyzed frequency components; and outputting, by a haptic output unit, a haptic effect based on the generated haptic output message, wherein the adaptive audio filter dynamically varies depending on the application or the user input event.

Obtaining the sound effects may include setting, by the acquisition unit, a sound source sampling rate; obtaining, by the acquisition unit, audio blocks from the sound effect generated by the electronic device based on the set sound source sampling rate; and sending, by the acquisition unit, the obtained audio blocks, together with the application or the user input event, to the analysis unit.

Setting the sound source sampling rate may include setting, by the acquisition unit, the sound source sampling rate based on the performance of the electronic device and the characteristics of the application running on the electronic device, or setting a sound source sampling rate, received from a user, as the sound source sampling rate.

Analyzing the frequency components may include analyzing, by the analysis unit, the frequency components of the sound effect by performing Fast Fourier Transform (FFT) on each of audio blocks received from the acquisition unit; and sending, by the analysis unit, the analyzed frequency components, together with the application or the user input event received from the acquisition unit, to the message configuration unit.

Generating the haptic output message may include detecting, by the message configuration unit, frequency components, each having a intensity equal to or higher than a threshold included in the detected adaptive audio filter, among the frequency components that are results of the frequency components analyzed by the analysis unit; detecting, by the message configuration unit, an output frequency corresponding to the detected frequency components from the detected adaptive audio filter; and generating, by the message configuration unit, the haptic output message including the detected output frequency.

The method may further include generating, by a haptic mode setting unit, adaptive audio filters based on the sound effects generated in response to the application or the user input event.

Generating the adaptive audio filters may include collecting, by the haptic mode setting unit, the sound effects generated in response to the application running on the electronic device or the user input event using the application or the user input event as a key; classifying, by the haptic mode setting unit, the collected sound effects into a plurality of types of sound effect data according to the application or the user input event; and generating, by the haptic mode setting unit, the adaptive audio filters based on the classified sound effect data.

Collecting the sound effects using the application or the user input event as the key may include collecting, by the haptic mode setting unit, the sound effects generated in response to the application or the user input event for a preset time.

Classifying the collected sound effects may include classifying, by the haptic mode setting unit, the collected sound effects into a plurality of types of sound effect data using a time, an audio frequency band, and the intensity of each frequency band as feature vectors.

Generating the adaptive audio filters may include generating, by the generation module, the adaptive audio filters, each including the name of the application, the user input event, and a plurality of frequency characteristics; and the frequency characteristics may include frequency components, a intensity threshold, and an output frequency.

The method may further include storing, by the haptic mode setting unit, the generated adaptive audio filters in an audio filter storage unit.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram of an apparatus for providing a haptic effect using a sound effect according to an embodiment of the present invention;

FIG. 2 is a block diagram of the haptic mode setting unit of FIG. 1;

FIG. 3 is a diagram illustrating the analysis module of FIG. 2;

FIG. 4 is a diagram illustrating the generation module of FIG. 2;

FIG. 5 is a diagram illustrating the acquisition unit of FIG. 1;

FIG. 6 is a diagram illustrating the analysis unit of FIG. 1;

FIG. 7 is a flowchart illustrating a method of providing a haptic effect using a sound effect according to an embodiment of the present invention;

FIG. 8 is a flowchart illustrating the step of generating an adaptive audio filter shown in FIG. 7;

FIG. 9 is a flowchart illustrating the step of providing a haptic effect using an adaptive audio filter shown in FIG. 7; and

FIG. 10 is a flowchart illustrating the step of collecting sound effects shown in FIG. 9.

### DESCRIPTION OF THE PREFERRED EMBODIMENTS

Embodiments of the present invention will be described with reference to the accompanying drawings in order to describe the present invention in detail so that those having ordinary knowledge in the technical field to which the present pertains can easily practice the present invention. It should be noted that like reference numerals are used to designate like elements throughout the drawings as much as possible. In the following description of the present invention, detailed descriptions of known functions and constructions which are deemed to make the gist of the present invention obscure will be omitted.

First, the characteristics of an apparatus and method for providing a haptic effect using a sound effect according to embodiments of the present invention will be described below.

A conventional apparatus for providing a haptic effect provides haptic effects in response to sound effects generated by an electronic device using a predetermined audio filter. The conventional apparatus for providing a haptic effect can be used only for the sound effects of a specific application because it generates the audio filter in advance based on the characteristics of each previously collected frequency band. Therefore, according to the conventional apparatus for providing a haptic effect, the audio filter should be reconfigured when the application is changed from the specific application to another application.

When the variety of applications and games provided by an electronic device is considered, an audio filter needs to be configured for a random sound effect in order to effectively output a haptic effect in response to a common sound effect.

In general, in many electronic devices, sound effects are commonly used as feedback for user input. In particular, in games, button input, joystick input, and touch screen input corresponding to the button input and the joystick input are frequently used to control games. These user input events are actually used to control game characters. When a user controls a game character, a sound effect is used at the same time that an input event, such as a movement, a change of direction, selection of an option, or use of an option, occurs.

In the present invention, the frequency distribution characteristics of sound effects generated for a preset time are analyzed based on a user input event, such as a touch or button input, which is frequently generated while a user uses an electronic device, and then an audio filter for a random sound effect is configured (e.g., changed or updated).

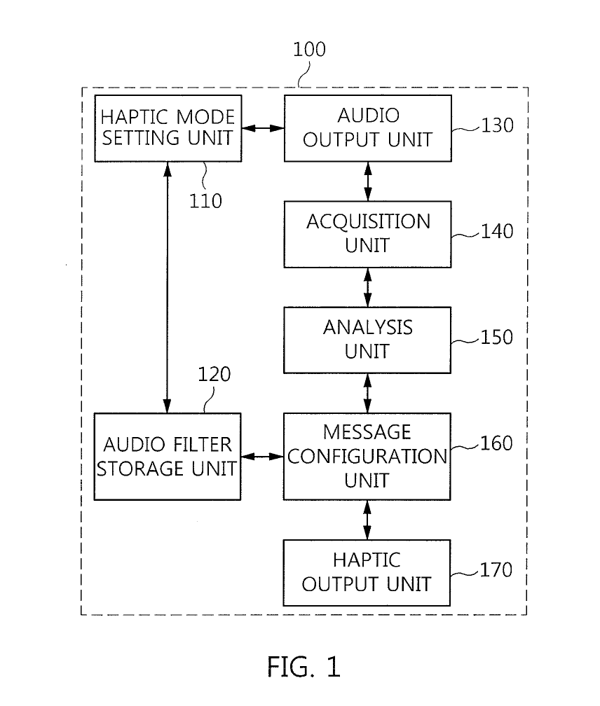

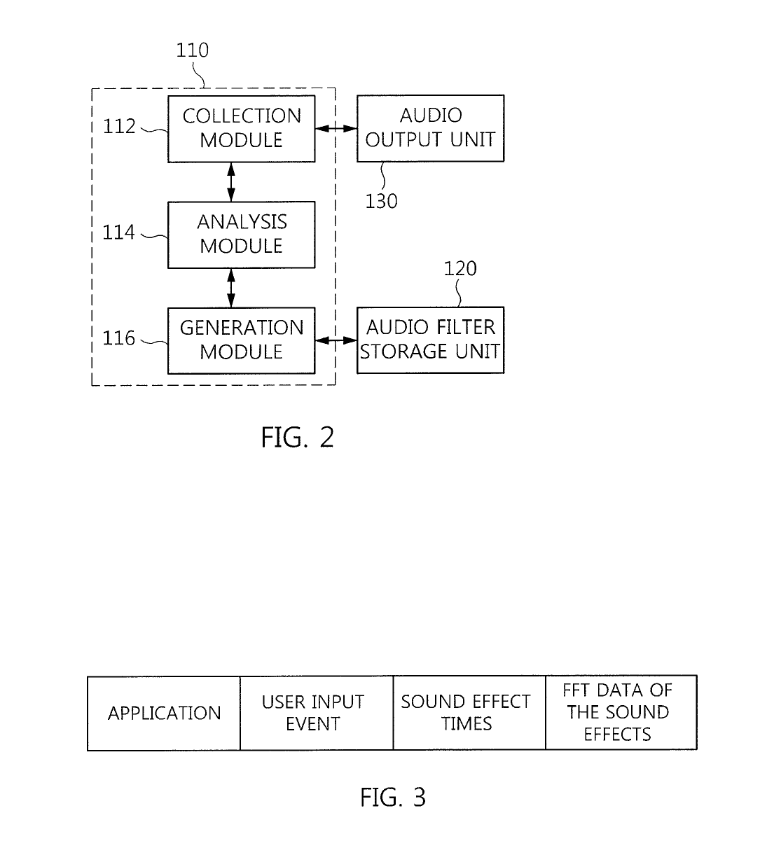

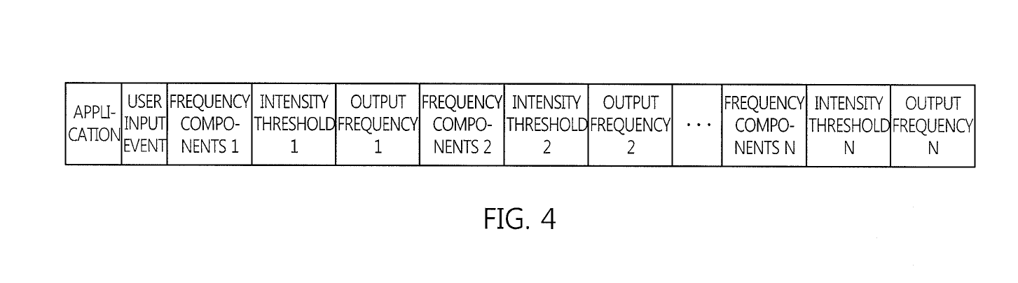

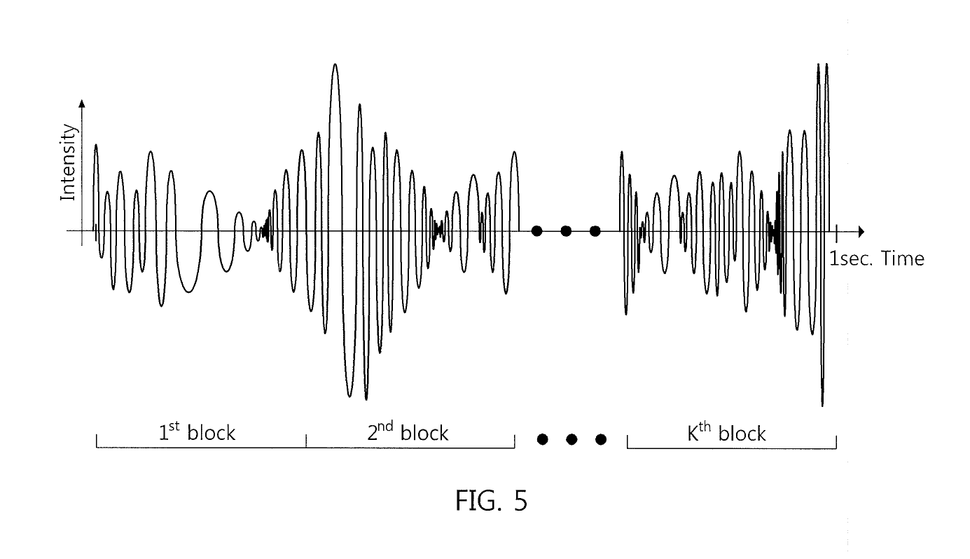

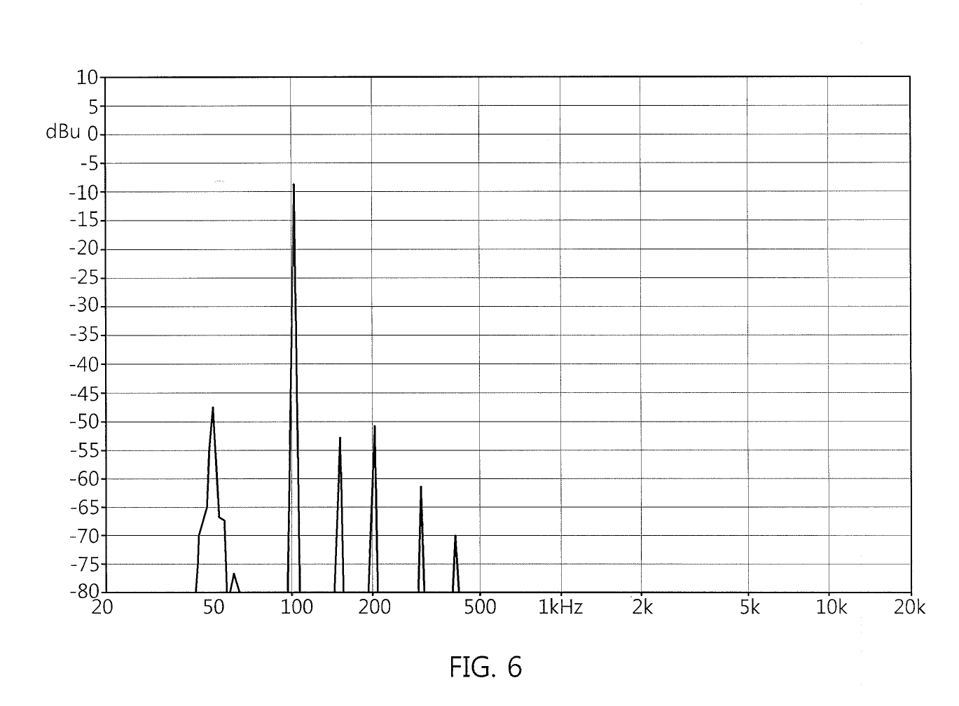

The apparatus for providing a haptic effect using a sound effect according to an embodiment of the present invention will be described in detail below with reference to the accompanying drawings. FIG. 1 is a block diagram of the apparatus for providing a haptic effect using a sound effect according to an embodiment of the present invention, FIG. 2 is a block diagram of the haptic mode setting unit of FIG. 1, FIG. 3 is a diagram illustrating the analysis module of FIG. 2, FIG. 4 is a diagram illustrating the generation module of FIG. 2, FIG. 5 is a diagram illustrating the acquisition unit of FIG. 1, and FIG. 6 is a diagram illustrating the analysis unit of FIG. 1.

The apparatus 100 for providing a haptic effect using a sound effect is contained in an electronic device in a modular form, and is configured to control the output of a haptic effect corresponding to audio generated by the electronic device. The apparatus 100 for providing a haptic effect using a sound effect controls the output of a haptic effect based on an adaptive audio filter that is generated using a sound effect that is generated in response to a user executed application or a user input event. The adaptive audio filter is not an audio filter fixed to a specific frequency band and the energy threshold of a specific frequency component, but is a filter that dynamically changes the meaningful frequency component of a sound effect, the energy threshold of the frequency component, etc., using a currently running application or a user input event, and a sound effect.

For this purpose, as shown in FIG. 1, the apparatus 100 for providing a haptic effect using a sound effect includes a haptic mode setting unit 110, an audio filter storage unit 120, an audio output unit 130, an acquisition unit 140, an analysis unit 150, a message configuration unit 160, and a haptic output unit 170.

The haptic mode setting unit 110 generates an adaptive audio filter based on a sound effect that is generated by the audio output unit 130. That is, the haptic mode setting unit 110 generates an adaptive audio filter using a sound effect that is generated in response to a user executed application or a user input event. In this case, the adaptive audio filter is a filter that dynamically changes the meaningful frequency component of a sound effect, the energy threshold of the frequency component, etc., using a currently running application or a user input event, and a sound effect.

For this purpose, as shown in FIG. 2, the haptic mode setting unit 110 includes a collection module 112, an analysis module 114, and a generation module 116.

The collection module 112 collects sound effects that are generated by an electronic device in response to the manipulation of a user. That is, the collection module 112 collects sound effects that are output by the audio output unit 130 in response to a user executed application or a user input event for a preset time. In this case, the collection module 112 may set the preset time differently depending on the electronic device, the application, or the user input event, and collects sound effects using the application or the user input event as a key.

The analysis module 114 classifies the collected sound effects into a plurality of types of sound effect data according to their frequency characteristics. That is, the analysis module 114 classifies the collected sound effects into a plurality of types of sound effect data using the time, the audio frequency band, and the intensity for each frequency band as feature vectors. As shown in FIG. 3, the analysis module 114 classifies the collected sound effects into a plurality of types of sound effect data, including applications, user input events, sound effect times, and the FFT data of the sound effects. Furthermore, the analysis module 114 classifies sound effects collected by the collection module 112 while a user plays a game in real time, and accumulates sound effects based on respective pairs of an application and a user input event. Even in the case of a sound effect for the same pair of an application and a user input event, the analysis module 114 may classify sound effects into different types of sound effect data according to their major frequency components or intensity for each frequency band.

The generation module 116 generates an adaptive audio filter based on the sound effect data that are classified by the analysis module 114. That is, the generation module 116 generates an adaptive audio filter capable of detecting corresponding sound effects based on the frequency components of sound effect data that are classified based on the pairs of an application and a user input event.

As shown in FIG. 4, the generation module 116 generates an adaptive audio filter, including an application, a user input event, frequency components 1 to n, intensity thresholds 1 to n, and output frequencies 1 to n. That is, the generation module 116 generates an adaptive audio filter, including a plurality of frequency components, a plurality of intensity thresholds, and a plurality of output frequencies in connection with one application and one user input event because various frequency components may be generated with respect to the same application or user input event. The intensity threshold n is the threshold of the audio output magnitude (intensity) of a frequency band corresponding to the frequency component n, and the output frequency is the output frequency of an actuator providing a haptic effect.

The generation module 116 sets an output frequency using the characteristics (i.e., a frequency component and a intensity threshold) of each frequency band. That is, the generation module 116 sets the output frequency of an actuator based on the characteristics of each frequency band in order to provide a haptic effect. The generation module 116 stores an adaptive audio filter, for which haptic effect information (i.e., an output frequency) has been set using the characteristics of each frequency band that appear in connection with each piece of audio data (i.e., each sound effect), in the audio filter storage unit 120. Accordingly, the audio data (i.e., the sound effect) can be easily distinguished from other sound effects, such as background music, and a haptic effect can be selectively generated with respect to an intended sound effect.

The audio filter storage unit 120 stores one or more adaptive audio filters that are generated by the haptic mode setting unit 110. That is, the audio filter storage unit 120 receives the adaptive audio filters, each including an application, a user input event, frequency components 1 to n, intensity thresholds 1 to n, and output frequencies 1 to n, from the generation module 116 of the haptic mode setting unit 110, and stores the received adaptive audio filters.

The audio filter storage unit 120 detects a stored adaptive audio filter in response to a request from the message configuration unit 160. That is, the audio filter storage unit 120 receives a request signal, including an application and a user input event, from the message configuration unit 160. The audio filter storage unit 120 detects one or more adaptive audio filters from among a plurality of stored adaptive audio filters using an application or a user input event, included in the response signal, as a key. The audio filter storage unit 120 sends the detected adaptive audio filter to the message configuration unit 160. In this case, the audio filter storage unit 120 detects one or more adaptive audio filters, and sends them to the message configuration unit 160.

The audio output unit 130 outputs audio data (i.e., a sound source or a sound effect) in accordance with the function of an application that operates in an electronic device. That is, the audio output unit 130 outputs audio data via a speaker in accordance with software or firmware that is executed in the electronic device. Although the audio output unit 130 is illustrated as being included in the apparatus 100 for providing a haptic effect using a sound effect in FIG. 1, the audio output unit 130 may be implemented as an audio output module embedded in an electronic device.

The acquisition unit 140 obtains a sound effect that is output by the audio output unit 130 when an application is executed or a user input event is generated. The acquisition unit 140 obtains the sound effect using the application or the user input event as a key.

In this case, the acquisition unit 140 obtains a plurality of audio blocks from the sound effect generated by the audio output unit 130 based on a sound source sampling rate (i.e., a preset time unit). That is, as shown in FIG. 5, the acquisition unit 140 divides a sound effect of a specific time at a sound source sampling rate (i.e., at preset time intervals), and obtains a plurality of audio blocks (i.e., a first audio block to an n-th audio block) from the sound effect.

In this case, the sound source sampling rate (k/sec) at which audio samples are obtained is related to the quality of finally output haptic output. That is, when the sound source sampling rate becomes higher, the quality of haptic output can be improved because a time delay does not occur when a haptic effect is output. In contrast, when the sound source sampling rate becomes lower, the quality of haptic output is deteriorated because a haptic effect having a time delay with audio being output is output.

However, as the sound source sampling rate increases, the computational load of an electronic device increases because the amount of work that should be processed by the electronic device after the acquisition of audio samples also increases. Accordingly, the acquisition unit 140 automatically sets the sound source sampling rate depending on the performance of an electronic device and the characteristics of an application running on the electronic device. In this case, the acquisition unit 140 may manually set the sound source sampling rate through user input.

The acquisition unit 140 sends the plurality of obtained audio blocks to the analysis unit 150 using an application or a user input event as a key. The acquisition unit 140 sends the obtained audio blocks to the analysis unit 150 at the sound source sampling rate as soon as it obtains the audio blocks. In this case, the acquisition unit 140 may send audio blocks, obtained at specific time intervals, to the analysis unit 150.

The analysis unit 150 analyzes the frequency components of each of the plurality of audio blocks received from the acquisition unit 140. In this case, the analysis unit 150 performs Fast Fourier Transform (FFT) on each of the audio blocks, and analyzes the frequency components of the audio block. For example, FIG. 6 shows an example in which the analysis unit 150 detects frequencies near 50 Hz, 100 Hz, 150 Hz, 200 Hz, 400 Hz, and 500 Hz from an audio block.

The analysis unit 150 sends one or more frequency components obtained by analyzing the audio block to the message configuration unit 160. In this case, the analysis unit 150 sends the application or the user input event, received along with the audio blocks, to the message configuration unit 160.

The message configuration unit 160 detects an adaptive audio filter from the audio filter storage unit 120 based on the key (i.e., the application and the user input event) received from the analysis unit 150. That is, the message configuration unit 160 requests the audio filter storage unit 120 to detect the adaptive audio filter while sending the application and the user input event received from the analysis unit 150 to the audio filter storage unit 120. The message configuration unit 160 receives the adaptive audio filter using the application or the user input event as a key, from the audio filter storage unit 120.

The message configuration unit 160 generates a haptic output message based on the detected adaptive audio filter and the frequency components received from the analysis unit 150. That is, the message configuration unit 160 detects an output frequency, corresponding to the frequency components, from the received adaptive audio filter. In this case, the message configuration unit 160 detects the output frequency corresponding to one or more frequency components.

The frequency components may vary depending on the characteristics of audio data. If haptic output is output with respect to all detected frequency components, a haptic effect corresponding to all audio data being output (i.e., a haptic effect generated by the operation of an actuator) is provided to a user. In order to maximize the user experience of a user who uses an application installed on the electronic device, it is effective to output a haptic effect corresponding to some audio data having effective haptic feedback, rather than to output a haptic effect corresponding to all the audio data being output. Accordingly, it is preferred that noise or meaningless frequency components be filtered out from detected frequency components based on the adaptive audio filter and a haptic effect corresponding to only meaningful frequency components be output to a user.

For this purpose, the message configuration unit 160 detects frequency components, each having a intensity equal to or higher than a threshold included in a previously detected adaptive audio filter, among the frequency components received from the analysis unit 150. The message configuration unit 160 detects an output frequency, corresponding to previously detected frequency components, from previously detected adaptive audio filters. The message configuration unit 160 generates a haptic output message including the detected output frequency. The message configuration unit 160 sends the generated haptic output message to the haptic output unit 170.

The haptic output unit 170 outputs a haptic effect by operating the actuator based on the haptic output message received from the message configuration unit 160. That is, the haptic output unit 170 outputs the haptic effect by operating the actuator at an output frequency corresponding to the output frequency included in the received haptic output message.

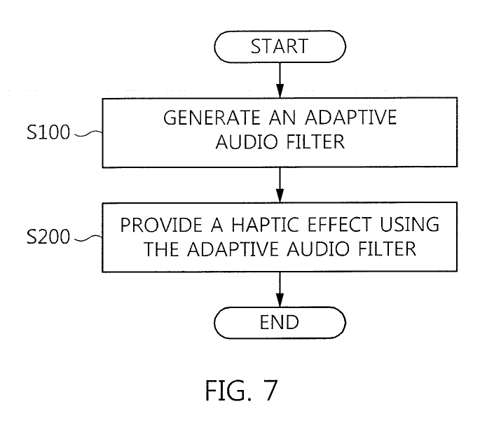

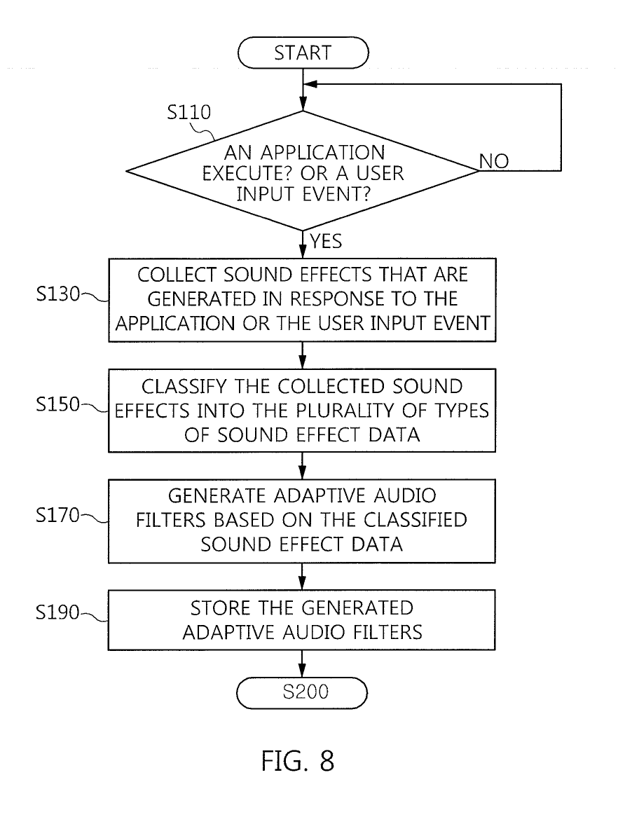

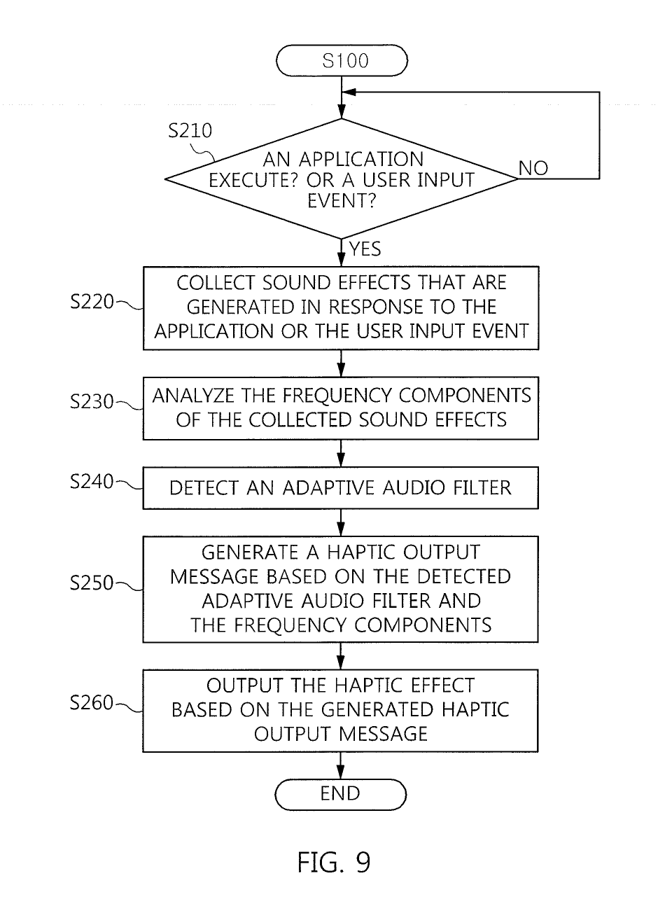

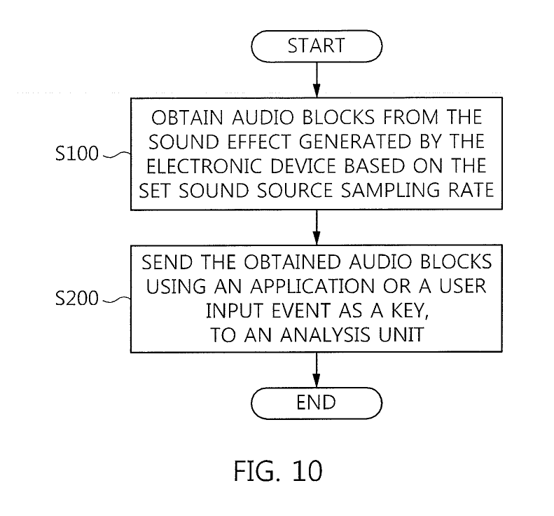

A method of providing a haptic effect using a sound effect according to an embodiment of the present invention will be described in detail below with reference to the accompanying drawings. FIG. 7 is a flowchart illustrating the method of providing a haptic effect using a sound effect according to an embodiment of the present invention, FIG. 8 is a flowchart illustrating the step of generating an adaptive audio filter shown in FIG. 7, FIG. 9 is a flowchart illustrating the step of providing a haptic effect using an adaptive audio filter shown in FIG. 7, and FIG. 10 is a flowchart illustrating the step of collecting sound effects shown in FIG. 9.

As shown in FIG. 7, the method of providing a haptic effect using a sound effect according to this embodiment of the present invention may basically include the step of generating an adaptive audio filter at step S100, and the step of providing a haptic effect using the adaptive audio filter at step S200.

At step S100, an adaptive audio filter is generated based on a sound effect that is generated by an electronic device in response to the manipulation of a user. This step will be described in greater detail below with reference to FIG. 8.

When an application is executed or a user input event is generated (YES at step S110), the haptic mode setting unit 110 collects sound effects that are generated in response to the application or the user input event at step S130. That is, the haptic mode setting unit 110 collects sound effects, generated by the audio output unit 130 in response to the user executed application or the user input event in an electronic device, for a preset time. In this case, the haptic mode setting unit 110 collects the sound effects using the application or the user input event as a key.

The haptic mode setting unit 110 classifies the sound effects, collected at step S130, into a plurality of types of sound effect data at step S150. That is, the haptic mode setting unit 110 classifies the collected sound effects into the plurality of types of sound effect data based on their frequency characteristics. The haptic mode setting unit 110 classifies the collected sound effects into the plurality of types of sound effect data using their time, audio frequency band, and intensity of the frequency band as feature vectors. Furthermore, the haptic mode setting unit 110 classifies the collected sound effects into the plurality of types of sound effect data, each including an application, a user input event, a sound effect time, and the FFT data of a sound effect.

The haptic mode setting unit 110 generates adaptive audio filters based on the classified sound effect data at step S170. That is, the haptic mode setting unit 110 generates the adaptive audio filters capable of detecting corresponding sound effects based on the frequency components of the sound effect data classified based on the application and the user input event. The haptic mode setting unit 110 generates the adaptive audio filters, each including an application, a user input event, frequency components, intensity thresholds, and output frequencies. In this case, the haptic mode setting unit 110 generates the adaptive audio filters, each including a plurality of frequency components, a plurality of intensity thresholds, and a plurality of output frequencies with respect to one application and one user input event because various frequency components can be generated with respect to the same application and user input event. The haptic mode setting unit 110 sets an output frequency using the characteristics (i.e., frequency components and intensity threshold) of each frequency band. That is, the generation module 116 sets the output frequency of an actuator that provides a haptic effect based on the characteristics of each frequency band.

The haptic mode setting unit 110 stores the generated adaptive audio filters in the audio filter storage unit 120 at step S190. That is, the haptic mode setting unit 110 sends the generated adaptive audio filters to the audio filter storage unit 120. The audio filter storage unit 120 receives the adaptive audio filters, each including an application, a user input event, frequency components, intensity thresholds, and output frequencies, from the generation module 116 of the haptic mode setting unit 110, and stores the received adaptive audio filters.

At step S200, haptic effects corresponding to meaningful sound effects among sound effects generated by an electronic device are provided to a user using the adaptive audio filters that are generated at step S100. Step S200 will be described in greater detail below with reference to FIGS. 9 and 10.

When an application is executed or a user input event is generated by the manipulation of a user (YES at step S210), the audio output unit 130 outputs sound effects in response to the execution of the application or the generation of the user input event. That is, the audio output unit 130 outputs audio data through a speaker using software or firmware that is executed on the electronic device.

The acquisition unit 140 collects the sound effects that are generated by the audio output unit 130 in response to the execution of the application or the generation of the user input event at step S220. The acquisition unit 140 obtains the sound effects using the application or the user input event as a key. This will be described in greater detail below with reference to FIG. 10.

The acquisition unit 140 obtains a plurality of audio blocks from each sound effect, generated by the audio output unit 130, based on a sound source sampling rate (i.e., preset time intervals) at step S222. That is, the acquisition unit 140 divides a sound effect of a specific time at a sound source sampling rate (i.e., preset time intervals), and obtains a plurality of audio blocks from the sound effect. In this case, the sound source sampling rate (k/sec) at which audio samples are obtained is related to the quality of finally output haptic output. That is, when the sound source sampling rate becomes higher, the quality of haptic output can be improved because a time delay is not generated when a haptic effect is output. In contrast, when the sound source sampling rate becomes lower, the quality of haptic output is deteriorated because a haptic effect having a time delay with audio being output is output. However, as the sound source sampling rate increases, the computational load of an electronic device increases because the amount of work that should be processed by the electronic device after the acquisition of audio samples also increases. Accordingly, the acquisition unit 140 automatically sets the sound source sampling rate depending on the performance of an electronic device and the characteristics of an application running on the electronic device. In this case, the acquisition unit 140 may manually set the sound source sampling rate through user input.

The acquisition unit 140 sends the plurality of obtained audio blocks to the analysis unit 150 using an application or a user input event as a key at step S224. The acquisition unit 140 sends the obtained audio blocks to the analysis unit 150 at the sound source sampling rate as soon as the audio blocks are obtained. In this case, the acquisition unit 140 may send audio blocks, obtained at specific time intervals, to the analysis unit 150.

The analysis unit 150 analyzes the frequency components of the collected sound effects at step S230. That is, the analysis unit 150 analyzes the frequency components of each of the audio blocks received from the acquisition unit 140 by performing Fast Fourier Transform (FFT) on the audio blocks. The analysis unit 150 sends one or more frequency components obtained by analyzing the audio block to the message configuration unit 160. In this case, the analysis unit 150 sends the application or the user input event received along with the audio blocks to the message configuration unit 160.

The message configuration unit 160 detects an adaptive audio filter from the audio filter storage unit 120 at step S240. That is, the message configuration unit 160 detects the adaptive audio filter from the audio filter storage unit 120 based on a key (i.e., the application or the user input event) that is received from the analysis unit 150. For this purpose, the message configuration unit 160 requests the audio filter storage unit 120 to detect the adaptive audio filter by sending the application or the user input event received from the analysis unit 150 to the audio filter storage unit 120. The audio filter storage unit 120 detects the adaptive audio filter, corresponding to the application or the user input event received from the message configuration unit 160, and sends the detected adaptive audio filter to the message configuration unit 160.

The message configuration unit 160 generates a haptic output message based on the detected adaptive audio filter and the frequency components received from the analysis unit 150 at step S250. That is, the message configuration unit 160 detects an output frequency, corresponding to the frequency components, from the received adaptive audio filter. In this case, the message configuration unit 160 detects the output frequency corresponding to one or more frequency components. The message configuration unit 160 detects frequency components, each having a intensity equal to or higher than a threshold included in a previously detected adaptive audio filter, among the frequency components received from the analysis unit 150. The message configuration unit 160 detects an output frequency, corresponding to previously detected frequency components, from a previously detected adaptive audio filter. The message configuration unit 160 generates a haptic output message including the detected output frequency. The message configuration unit 160 sends the generated haptic output message to the haptic output unit 170.

The haptic output unit 170 outputs a haptic effect by operating the actuator based on the haptic output message received from the message configuration unit 160 at step S260. That is, the haptic output unit 170 outputs the haptic effect by operating the actuator in an output frequency corresponding to the output frequency included in the received haptic output message.

As described above, according to the apparatus and method for providing a haptic effect using a sound effect according to the present invention, frequency components are detected by performing Fast Fourier Transform (FFT) on audio blocks obtained through sampling, and frequency components whose haptic effects do not need to be provided are removed from the detected frequency components based on previously stored adaptive audio filters. Accordingly, the apparatus and method for providing a haptic effect using a sound effect are advantageous in that a user experience attributable to haptic feedback can be maximized by filtering out frequency components whose haptic effects do not need to be provided, such as noise and background music.

Furthermore, the apparatus and method for providing a haptic effect using a sound effect are advantageous in that the complexity of a frequency filtering process attributable to audio frequency components being output can be overcome by storing adaptive audio filters, each including frequency components, a threshold, and the output frequency of an actuator, and filtering frequency components based on the stored adaptive audio filters.

Furthermore, according to the apparatus and method for providing a haptic effect using a sound effect, the audio filter storage unit is configured to have effective adaptive audio filters based on audio characteristics, a user can selectively set an adaptive audio filter depending on an application installed on an electronic device, and a user can select a sound effect capable of improving a user experience. Accordingly, the apparatus and method for providing a haptic effect using a sound effect are advantageous in that a background sound effect can be easily separated and audio can be easily converted into haptic feedback with respect to a specific sound effect.

Furthermore, the apparatus and method for providing a haptic effect using a sound effect are advantageous in that haptic feedback effectively responding to a specific sound effect can be provided to a user without the intervention of the user by automatically changing an audio filter in response to an application or an input event and a sound effect instead of an existing method of a user selecting an audio filter in order to provide a user with a different haptic effect depending on an application installed on an electronic device.

Furthermore, the apparatus and method for providing a haptic effect using a sound effect are advantageous in that an audio filter can be dynamically changed in response to an application or a user input event and a meaningful sound effect can be effectively filtered by providing a haptic effect using an adaptive audio filter in which the frequency components of a meaningful sound effect and the energy threshold of the frequency components are dynamically changed in response to a running application or a user input event and a sound effect without using a conventional audio filter fixed to a specific frequency band and the energy threshold of a frequency component.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for providing a haptic effect using a sound effect, comprising:
an audio filter storage unit configured to store a plurality of adaptive audio filters;
an acquisition unit configured to obtain sound effects output by an electronic device in response to an application or a user input event;
an analysis unit configured to analyze frequency components of each of the sound effects obtained by the acquisition unit;
a message configuration unit configured to detect at least one of the adaptive audio filters from the audio filter storage unit based on the application or the user input event, and to generate a haptic output message, corresponding to the sound effect, based on the detected adaptive audio filter and the frequency components analyzed by the analysis unit; and
a haptic output unit configured to output a haptic effect based on the haptic output message received from the message configuration unit,
wherein the adaptive audio filter dynamically varies depending on the application or the user input event.

2. The apparatus of claim 1, wherein:
the audio filter storage unit stores a name of the application, the user input event, and a plurality of frequency characteristics; and
the frequency characteristics comprise frequency components, a intensity threshold, and an output frequency.

3. The apparatus of claim 1, wherein the acquisition unit obtains audio blocks from the sound effect generated by the electronic device based on a sound source sampling rate, and sends the obtained audio blocks, together with the application or the user input event, to the analysis unit.

4. The apparatus of claim 3, wherein the acquisition unit sets the sound source sampling rate based on performance of the electronic device and characteristics of the application running on the electronic device, or sets a sound source sampling rate received from a user as the sound source sampling rate.

5. The apparatus of claim 1, wherein the analysis unit analyzes the frequency components of the sound effect by performing Fast Fourier Transform (FFT) on each of audio blocks received from the acquisition unit, and sends the analyzed frequency components, together with the application or the user input event received from the acquisition unit, to the message configuration unit.

6. The apparatus of claim 1, wherein the message configuration unit detects frequency components, each having a intensity equal to or higher than a threshold included in the detected adaptive audio filter, among the frequency components received from the analysis unit, detects an output frequency corresponding to the detected frequency components from the detected adaptive audio filter, and generates the haptic output message including the detected output frequency.

7. The apparatus of claim 1, further comprising a haptic mode setting unit configured to generate the adaptive audio filter based on the sound effect generated in response to the application or the user input event and to store the generated adaptive audio filter in the audio filter storage unit.

8. The apparatus of claim 7, wherein the haptic mode setting unit comprises:
a collection module configured to collect the sound effects generated in response to the application executed on the electronic device or the user input event using the application or the user input event as a key;
an analysis module configured to classify the collected sound effects into a plurality of types of sound effect data according to the application or the user input event using a time, an audio frequency band, and a intensity of each frequency band as feature vectors; and
a generation module configured to generate adaptive audio filters based on the classified sound effect data.

9. The apparatus of claim 8, wherein:
the generation module generates the adaptive audio filters, each including a name of the application, the user input event, and a plurality of frequency characteristics; and
the frequency characteristics include frequency components, a intensity threshold, and an output frequency.

10. A method of providing a haptic effect using a sound effect, comprising:
obtaining, by an acquisition unit, sound effects generated by an electronic device in response to an application or a user input event;
analyzing, by an analysis unit, frequency components of each of the obtained sound effects;
detecting, by a message configuration unit, at least one adaptive audio filter based on the application or the user input event;
generating, by the message configuration unit, a haptic output message, corresponding to the sound effect, based on the detected adaptive audio filter and the analyzed frequency components; and
outputting, by a haptic output unit, a haptic effect based on the generated haptic output message,
wherein the adaptive audio filter is dynamically changed in response to the application or the user input event.

11. The method of claim 10, wherein obtaining the sound effects comprises:
setting, by the acquisition unit, a sound source sampling rate;
obtaining, by the acquisition unit, audio blocks from the sound effect generated by the electronic device based on the set sound source sampling rate; and
sending, by the acquisition unit, the obtained audio blocks, together with the application or the user input event, to the analysis unit.

12. The method of claim 11, wherein setting the sound source sampling rate comprises setting, by the acquisition unit, the sound source sampling rate based on performance of the electronic device and characteristics of the application running on the electronic device, or setting a sound source sampling rate, received from a user, as the sound source sampling rate.

13. The method of claim 10, wherein analyzing the frequency components comprises:
analyzing, by the analysis unit, the frequency components of the sound effect by performing Fast Fourier Transform (FFT) on each of audio blocks received from the acquisition unit; and
sending, by the analysis unit, the analyzed frequency components, together with the application or the user input event received from the acquisition unit, to the message configuration unit.

14. The method of claim 10, wherein generating the haptic output message comprises:
detecting, by the message configuration unit, frequency components, each having a intensity equal to or higher than a threshold included in the detected adaptive audio filter, among the frequency components that are results of the frequency components analyzed by the analysis unit;
detecting, by the message configuration unit, an output frequency corresponding to the detected frequency components from the detected adaptive audio filter; and
generating, by the message configuration unit, the haptic output message including the detected output frequency.

15. The method of claim 10, further comprising generating, by a haptic mode setting unit, adaptive audio filters based on the sound effects generated in response to the application or the user input event.

16. The method of claim 15, wherein generating the adaptive audio filters comprises:
collecting, by the haptic mode setting unit, the sound effects generated in response to the application running on the electronic device or the user input event using the application or the user input event as a key;
classifying, by the haptic mode setting unit, the collected sound effects into a plurality of types of sound effect data according to the application or the user input event; and
generating, by the haptic mode setting unit, the adaptive audio filters based on the classified sound effect data.

17. The method of claim 16, wherein collecting the sound effects using the application or the user input event as the key comprises collecting, by the haptic mode setting unit, the sound effects generated in response to the application or the user input event for a preset time.

18. The method of claim 16, wherein classifying the collected sound effects comprises classifying, by the haptic mode setting unit, the collected sound effects into a plurality of types of sound effect data using a time, an audio frequency band, and a intensity of each frequency band as feature vectors.

19. The method of claim 16, wherein:
generating the adaptive audio filters comprises generating, by the generation module, the adaptive audio filters, each including a name of the application, the user input event, and a plurality of frequency characteristics; and
the frequency characteristics comprise frequency components, a intensity threshold, and an output frequency.

20. The method of claim 16, further comprising storing, by the haptic mode setting unit, the generated adaptive audio filters in an audio filter storage unit.
